(19) United States
(12) Patent Application Publication
(10) Pub. No.: US 2026/0227749 A1
(43) Pub. Date: Aug. 6, 2026

(54) Systems And Methods For Disaggregating Grid Power Profiles For Identifying A Flexibility Potential For Behind-The-Meter Assets

(71) Applicant: Siemens Aktiengesellschaft, Munchen (DE)

(72) Inventors: Michael Metzger, Munchen (DE); Sebastian Schreck, Erlangen (DE); Thomas Baumgärtner, Erlangen (DE); Thomas Schütz, Erlangen (DE); Ileskhan Kalysh, Erlangen (DE); Sebastian Sahlender, Munchen (DE); Sebastian Thiem, Erlangen (DE)

(73) Assignee: Siemens Aktiengesellschaft, Munchen (DE)

(21) Appl. No.: 19/463,589

(22) Filed: Jan. 29, 2026

(30) Foreign Application Priority Data
Jan. 29, 2025 (EP) 25154765.9

(51) Int. Cl. G05B 13/02; H02J 13/12

(52) U.S. Cl. CPC G05B 13/0265; H02J 13/12

(57) ABSTRACT

Various embodiments of the teachings herein include a method for operating a power grid based on profiles for identifying a flexibility potential for behind-the-meter assets. An example includes: accessing time-dependent grid meter data; accessing time-dependent weather data; determining at least one rated photovoltaic power; disaggregating the grid meter data using machine learning algorithms to identify distributed energy resources (DER); determining a flexibility potential for the identified behind-the-meter DER; and operating the power grid based on the flexibility potential.

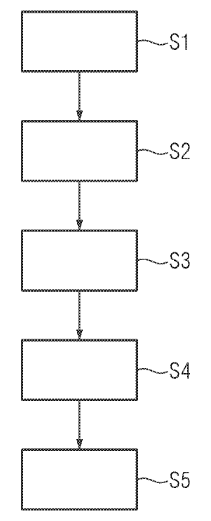

### CROSS-REFERENCE TO RELATED APPLICATIONS

This application claims priority to EP Application No. 25154765.9 filed January 29, 2025, the contents of which are hereby incorporated by reference in their entirety.

### TECHNICAL FIELD

The present disclosure relates to power grids. Various embodiments of the teachings herein may include methods and/or systems for disaggregating grid power profiles for identifying a flexibility potential for behind-the-meter assets.

### BACKGROUND

An electrical power grid is a complex network that serves to supply electricity from power generation sources to end consumers. Traditionally, the flow of power in distribution grids was unidirectional, with electrical energy transferred from centralized power plants through transmission and distribution grids to private and commercial customers. However, the increasing use of distributed energy resources (DERs), such as photovoltaic systems, battery storage units and charging stations for electric vehicles (EV), has turned many consumers into "prosumers", i.e. entities that can both consume and produce power.

This shift toward distributed energy generation and storage poses new challenges for grid operators, especially at the distribution grid level. Distribution system operators (DSOs) are challenged with managing bidirectional power flows, overcoming increased supply and demand variability, and preventing potential voltage and transformer limit violations. The intermittent nature of renewable energy sources, such as solar and wind, coupled with the unpredictable charging patterns of EVs, has created a need for greater flexibility in both energy generation and consumption in order to maintain grid stability and reliability.

A major challenge in managing this evolving grid landscape is the limited visibility of so-called behind-the-meter assets. Many DERs, especially in residential buildings, are installed on the customer side of the electricity meter, that is to say behind the meter in this sense. While the total net load or generation is measured, the individual contributions of various behind-the-meter assets, such as PV systems, battery storage units or EV charging stations, are often not measured separately or are not visible to the grid operator. This lack of granular data makes it difficult for grid operators to accurately predict and manage power flows, potentially resulting in inefficient grid operation and an increased risk of system instability.

In addition, traditional methods of load forecasting and grid management based on standardized load profiles are becoming less effective as prosumer behaviors become increasingly diverse and dynamic.

### SUMMARY

The teachings of the present disclosure may be used in systems and methods for determining the flexibility potential of behind-the-meter energy resources (DERs) in order to enable more effective grid management of the power grid. For example, some embodiments include a computer-implemented method for disaggregating grid power profiles for identifying a flexibility potential for behind-the-meter assets (DERs), wherein the method is characterized by the following: (S1) providing time-dependent grid meter data, in particular with a temporal resolution of at least 15 minutes; (S2) providing time-dependent weather data, which include global radiation data, in particular with a temporal resolution of at least 15 minutes; (S3) providing at least one rated photovoltaic power; (S4) disaggregating the grid meter data using machine learning algorithms to identify the DERs; and (S5) determining the flexibility potential for the identified behind-the-meter DERs.

In some embodiments, the DERs include at least one of the following behind-the-meter assets: PV systems, battery storage systems and/or charging stations for electric vehicles.

In some embodiments, the determination of the flexibility potential includes: determining a maximum curtailment of PV production during a given period of time; determining a maximum charging and/or discharging capacity of battery storage systems; and/or determining a flexibility of the charging of electric vehicles based on historical charging statistics.

In some embodiments, the disaggregation of the grid meter data includes identifying a share of a heating, ventilation and/or air-conditioning system load.

In some embodiments, the calculation of the flexibility potential includes calculating a lower limit for the flexibility of the heating based on the identified HVAC load share and a typical thermal inertia for a building at an outside temperature at its location.

In some embodiments, the method includes using transfer learning to estimate flexible assets and parameters of locations to be classified based on already classified behind-the-meter DER systems and their respective flexibility parameters.

In some embodiments, the machine learning algorithms include customizable rule-based algorithms and trainable machine learning algorithms.

As another example, some embodiments include a system for disaggregating grid power profiles to identify a flexibility potential for behind-the-meter assets, in particular distributed energy resources (DERs), wherein the system comprises: a module, designed to receive time-dependent grid meter data, in particular with a temporal resolution of at least 15 minutes, time-dependent weather data, which include global radiation data, in particular with a temporal resolution of at least 15 minutes, and rated photovoltaic power data from a DER; a computing unit, designed: to disaggregate the grid meter data using machine learning algorithms in order to identify the DERs; to determine the flexibility potential for the identified behind-the-meter DERs; and to provide the determined flexibility potential.

In some embodiments, the behind-the-meter-DERs include at least one PV system, a battery storage system and/or a charging station for electric vehicles.

In some embodiments, the computing unit is designed: to determine a maximum curtailment of PV production during a given period of time; to determine a maximum charging or discharging capacity of battery storage systems; and/or to determine a flexibility of the EV charging based on historical charging statistics.

In some embodiments, the computing unit is designed to identify a share of a heating, ventilation and/or air-conditioning system load during disaggregation of the grid meter data.

In some embodiments, the computing unit is designed to calculate a lower limit for the flexibility of the heating based on the identified air-conditioning system load share and a typical thermal inertia for a building at an external temperature at its location.

In some embodiments, the computing unit is designed to use transfer learning to estimate flexible assets and parameters of locations to be classified based on already classified behind-the-meter DER assets and their respective flexibility parameters.

In some embodiments, the machine learning algorithms include customizable rule-based algorithms and trainable machine learning algorithms.

As another example, some embodiments include a computer program product comprising commands that, when the program is executed by a computing unit, in particular a computer, cause said computing unit to carry out one or more of the methods as described herein.

### BRIEF DESCRIPTION OF THE DRAWING

Further advantages, features, and/or details of the teachings herein can be found in the embodiments described below and in the figure. The figure schematically shows a flowchart of an example method incorporating teachings of the present disclosure for disaggregating grid power profiles to identify a flexibility potential for behind-the-meter assets.

### DETAILED DESCRIPTION

Some embodiments of the teachings herein include methods and/or systems for disaggregating grid power profiles for identifying a flexibility potential for behind-the-meter assets. An example method includes:

providing time-dependent grid meter data, in particular with a temporal resolution of at least 15 minutes; providing time-dependent weather data, which includes global radiation data, in particular with a temporal resolution of at least 15 minutes; providing at least one rated photovoltaic power; disaggregating the grid meter data using machine learning algorithms (AI) to identify the DERs; and determining the flexibility potential for the identified behind-the-meter DERs.

The term grid power profiles refers to the aggregated electrical power consumption and/or power generation data measured over time at a single point of connection, typically the supply meter, for a specific location. These data represent the combined effect of all electrical loads and generation sources behind the meter, typically without distinguishing individual components or assets. The grid power profiles can also be referred to as load profiles.

Behind-the-meter assets or DERs (distributed energy resources) are energy generation and/or energy storage technologies installed on the customer side of the supply meter. The term DER may include, but is not limited to, photovoltaic systems, battery storage systems, charging stations for electric vehicles and/or other assets, in particular intelligent devices. These assets can consume and/or produce power, and so they affect the overall grid power profile of a location.

Flexibility potential in the context of power systems may relate to the ability of electrical loads and/or generation sources to change their power consumption and/or their power production in response to external signals and/or incentives. This may include a change, increase and/or decrease in power output, a shift in energy consumption to other times, and/or the provision of other grid services.

Disaggregation means breaking down the combined or common grid power profile of the assets into the contributions of the individual assets. The individual contributions of various behind-the-meter assets and/or loads are identified and quantified with regard to their power consumption and/or power production.

In particular, machine learning algorithms are calculation methods that use statistical methods to enable computer systems to "learn" from data and improve their performance for a given task without being explicitly programmed (AI). In the context of the disaggregation of power profiles, these algorithms can identify patterns, properties and/or influences of various energy-consuming and/or energy-generating assets within the aggregated data.

Temporal resolution refers to the frequency at which data points are recorded and/or measured over time. A temporal resolution of at least 15 minutes means that power and/or weather data are measured at intervals of at most 15 minutes, providing a detailed time series for analysis.

Global radiation data refers to measurements of the power received by the sun per unit area. These data are beneficial for estimating the power of photovoltaic systems. The global radiation data is typically expressed in watts per square meter (W/m²).

Rated photovoltaic power data refers to the rated power of a photovoltaic system under standard test conditions. These data represent the maximum power that the system should generate under ideal conditions and is typically expressed in kilowatt peak (kWp).

Transfer learning is a machine learning method in which knowledge gained from training one model for one task is applied to another related task. In the context of this invention, this may include the use of findings from already classified DER assets to improve the classification and parameter estimation of new, non-classified locations.

The methods incorporating teachings of the present disclosure may have multiple advantages over known solutions for identifying flexibility potentials in behind-the-meter assets. By combining high-resolution grid meter data, detailed weather information, and rated photovoltaic power data, the method provides a comprehensive approach to disaggregating grid power profiles. This complete data integration enables a more accurate identification of distributed energy resources (DERs) and their individual contributions to the overall power profile (grid power profile). This will improve the control/regulation of electricity grids by grid operators.

The use of machine learning algorithms, especially neural networks (AI), for the disaggregation represents a significant improvement over known rule-based or statistical methods. These algorithms can recognize subtle patterns and/or correlations within the data that conventional approaches may overlook. This improved analytical capability allows for improved and broader identification of DERs, including those that may not be officially registered with the distribution system operator. As a result, the teachings herein may provide a more complete and accurate picture of the available flexibility potential within a particular area and allows for more effective grid management and optimization of the operation of the DERs.

These methods may be used to determine the flexibility potential for identified behind-the-meter DERs. This addresses a critical need in modern electricity systems, where the increasing pervasion of variable renewable energy sources and new electricity consumers, such as electric vehicles and heat pumps, has created a need for greater system flexibility. By quantifying the potential of each identified DER to adjust their electricity consumption and/or electricity generation, the method enables grid operators to make advantageous control decisions and/or regulatory decisions about load balancing, bottleneck management and overall system stability. This is especially valuable to prevent unexpected violations of voltage and transformer limits that can occur when prosumers behave in a manner that is different from standard load profiles.

Furthermore, the teachings go beyond a simple capacity estimation. By analyzing historical data patterns and correlating them with weather information, they can provide insight into the timing and reliability of available flexibility. This temporal dimension of the flexibility assessment is crucial for effective grid management, as it allows operators to anticipate when and where flexibility resources will be available. Such predictability is particularly valuable in dealing with the intermittent nature of renewable energy sources and the variable charging patterns of electric vehicles and enables more proactive and more efficient grid operation.

In addition, the ability of the method to disaggregate different types of behind-the-meter assets, such as PV systems, battery storage units and charging stations for electric vehicles, offers a granularity that has been difficult to achieve until now. This detailed breakdown of energy consumption and energy production behind the meter enables targeted flexibility programmes and more precise demand management strategies. Grid operators can now tailor their approaches to specific types of DER, maximizing the effectiveness of their flexibility usage and potentially reducing the need for costly grid upgrades.

The present disclosure offers important developments in the field of grid management and DER integration. By providing a data-driven, machine-learning-based approach to disaggregating grid power profiles and identifying flexibility potentials, it equips grid operators with the technical tools needed to cope with the complexity of modern, distributed energy systems. This improved capability not only improves grid stability and grid efficiency, but also paves the way to greater integration of renewable energy sources and innovative energy technologies, thereby contributing to the overall goal of a more sustainable and resilient electricity infrastructure.

An example system incorporating teachings of the present disclosure for disaggregating grid power profiles to identify a flexibility potential for behind-the-meter assets, in particular distributed energy resources (DERs), includes:

a module, designed to receive time-dependent grid meter data, in particular with a temporal resolution of at least 15 minutes, time-dependent weather data, which include global radiation data, in particular with a temporal resolution of at least 15 minutes, and rated photovoltaic power data from a DER; a computing unit, designed:

to disaggregate the grid meter data using machine learning algorithms in order to identify the DERs;

to determine the flexibility potential for the identified behind-the-meter DERs; and

to provide the determined flexibility potential, in particular for the control and/or regulation of an electricity grid.

Similar and equivalent advantages and configurations having the same effect result from the methods described herein.

An example computer program product incorporating teachings of the present disclosure comprises commands that, when the program is executed by a computing unit, in particular a computer, cause said computing unit to carry out one or more of the methods for disaggregating grid power profiles for behind-the-meter assets as described herein. Similar and equivalent advantages and configurations having the same effect result from the methods described herein.

In some embodiments, the behind-the-meter assets include at least one PV system, a battery storage system and/or charging station for electric vehicles (EV). This provides a comprehensive approach to identifying and analyzing the most common and influential behind-the-meter energy resources. By focusing on PV systems, battery storage systems and/or EV charging stations, the method advantageously captures a substantial share of the flexibility potential available in modern residential and commercial environments.

PV systems offer the advantage of clean, renewable energy generation, but their power is inherently variable due to weather conditions. The inclusion of PV systems in the analysis allows better prediction of potential energy surpluses, especially during peak periods of sunshine, and enables more effective grid operation by leveraging this flexibility potential.

Battery storage systems provide a critical buffer in the energy ecosystem and, in particular, allow for a time shift in energy and peak load smoothing. Their inclusion in the analysis enables more accurate identification or determination of the flexibility potential, as these systems can both take up excess energy in times of low demand and provide additional power in times of high demand.

EV charging stations represent a growing and significant load for the grid or electricity grid/distribution grid. Their inclusion is particularly advantageous as they act both as significant electricity consumers and, in particular with vehicle-to-grid technology, as a potential source of stored energy. Understanding their usage patterns and their flexibility potential is crucial for future grid stability.

Alternative or complementary embodiments could include other types of behind-the-meter assets, such as smart devices, heat pumps and/or micro combined heat and power (CHP) systems. The method could be expanded to include these additional DERs if they become more prevalent in the energy landscape.

In some embodiments, the determination of the flexibility potential includes:

determining a maximum curtailment of PV production during a given period of time; determining a maximum charging and/or discharging capacity of battery storage systems; and/or determining a flexibility of the charging of electric vehicles based on historical charging statistics.

This provides a comprehensive approach for quantifying the flexibility potential of various types of behind-the-meter DERs. By determining the maximum curtailment of the PV generation, the method enables grid operators to analyze the upper limit of controllable solar power reduction during periods of oversupply and/or grid overload. This information is crucial for maintaining grid stability and preventing voltage violations, especially in areas with high PV pervasion.

Determining the maximum charging and/or discharging capacity of battery storage systems provides insight into the available energy buffer capacities within the grid. This knowledge enables more effective use of stored energy for load balancing, peak load smoothing and/or grid support services.

Determining the flexibility of EV charging based on historical statistics provides a realistic view of how EV loads can be shifted and/or adjusted. This approach takes into account actual user behavior and results in more accurate and more reliable flexibility estimates compared to methods based solely on theoretical charging capacities.

Alternative or complementary embodiments may include real-time determination of the flexibility potential based on current conditions and forecasts, rather than relying solely on historical data. In addition, the method could be extended to include predictive modeling of the future flexibility potential based on trends in the adoption of DERs and usage patterns.

In some embodiments, the disaggregation of the grid meter data includes identifying a share of the heating, ventilation and/or air-conditioning systems (HVAC load). This improves the granularity of the disaggregation by specifically identifying the HVAC load share within the overall energy consumption profile (grid power profile). HVAC systems often represent a significant share of building energy consumption and offer great potential for demand response and energy efficiency improvements.

By isolating the HVAC load share, the method also provides valuable information about temperature-dependent energy consumption patterns. This information can be used to develop and/or apply more targeted and more effective strategies for load shifting and peak load reduction, especially during extreme weather events when HVAC usage tends to increase.

In addition, understanding the HVAC load share enables improved forecasting of the energy demand based on weather forecasts, allowing grid operators to more accurately detect fluctuations in energy consumption and thus better prepare for them.

Alternative or complementary implementations could include the disaggregation of other important load categories such as lighting, cooling, or industrial processes, depending on the specific application and the data available. The method could also be expanded to include data from smart thermostats for more accurate HVAC load identification and control.

In some embodiments, the calculation of the flexibility potential includes calculating a lower limit for the flexibility of the heating based on the identified HVAC load share and a typical thermal inertia for a building at an outside temperature at its location. This provides a conservative estimate of the flexibility potential of heating systems, which is particularly valuable for grid operators. By calculating a lower limit, the method ensures that the estimated flexibility is reliably available, thus reducing the risk of overestimating the system responsiveness.

Taking into account the typical thermal inertia of a building in conjunction with external temperature data enables a more accurate determination/calculation of how much and how long heating loads can be adjusted without significantly affecting the comfort of the occupants. This takes into account the building's ability to store heat. The configuration also provides a more realistic view of the potential for load shifting and/or demand response events. The use of location-specific external temperature data further refines the flexibility calculation by taking into account regional climate variations and their effects on the heating demand and flexibility potential.

Alternative or complementary implementations could include more complex thermal building models that take into account factors such as insulation quality, building orientation and/or occupancy patterns. In addition, the method could be extended to calculate upper limits of the flexibility potential and/or to provide a range of flexibility estimates based on different comfort thresholds.

In some embodiments, the method comprises using transfer learning to estimate flexible assets and parameters of locations to be classified based on already classified behind-the-meter DER systems and their respective flexibility parameters. This utilizes the advantages of transfer learning to improve the efficiency and accuracy of the classification of new locations and the estimation of their flexibility potential. By leveraging knowledge gained from previously classified DER assets, the method can assess the properties of new, unclassified locations more quickly and more accurately.

Transfer learning in this case enables improved generalization of the disaggregation models and flexibility estimation models, especially when limited data is available for new locations. This approach can significantly reduce the time and amount of data required to accurately classify and estimate the flexibility of new DER assets, and enables the method to be scaled more quickly across different regions or installation types. In addition, transfer learning can help identify regional or location-specific variations in DER power and flexibility potential. This results in more accurate estimates.

Alternative or complementary implementations could include federated learning techniques to improve model power while ensuring data security. Furthermore, it would be possible to use ensemble methods that combine transfer learning with other machine learning approaches for even more robust estimates.

In some embodiments, the machine learning algorithms include customizable rule-based algorithms and trainable machine learning algorithms. This combines the advantages of rule-based and trainable machine learning algorithms and enables a flexible and efficient approach for disaggregating grid meter data and estimating/determining the flexibility potential.

Customizable rule-based algorithms enable consideration of domain expertise and known physical/technical limitations in the disaggregation. These rules can be tailored to specific types of DER or regional characteristics to ensure that results are consistent with established technical principles and regulatory requirements. On the other hand, trainable machine learning algorithms can reveal complex patterns and relationships within the data that may not be immediately recognizable or easily codified into rules. These algorithms can adapt to changing conditions and improve their effectiveness over time as more data becomes available.

The combination of these two approaches enables a more robust and more adaptable system that can handle a wide range of scenarios and DER types. The rule-based components provide a solid foundation and interpretability, while the trainable components provide the flexibility to capture nuanced behaviors and evolve with changing energy landscapes.

Alternative or complementary implementations could maintain the use of explainable AI techniques to provide more transparent insight into the decision-making processes of machine learning algorithms. In addition, the system could be designed to automatically adjust the balance between rule-based and trainable components based on the quality and quantity of available data for each location and/or region.

The figure shows an example method comprising elements S1 to S5, which can be carried out successively and/or in parallel, each contributing to the identification and quantification of the flexibility potential of distributed energy resources (DERs).

The step S1 involves providing time-dependent grid meter data. These data preferably have a temporal resolution of at least 15 minutes and provide a detailed overview of the energy consumption patterns and/or energy production patterns at a particular location. The high temporal resolution is advantageous for capturing the dynamic behavior of various behind-the-meter assets, such as photovoltaic systems, battery storage systems and/or charging stations for electric vehicles. Even higher resolutions, such as 5 minute or 1 minute intervals, could be used here to capture even faster changes in energy patterns. This may be advantageous for fast-reacting assets, such as battery storage units.

In accordance with step S2, time-dependent weather data, including global radiation data, is provided. These weather data also typically have a temporal resolution of at least 15 minutes, corresponding to the resolution of the grid meter data. The consideration of global radiation data is particularly advantageous for estimating the power of photovoltaic systems. Other weather parameters, such as temperature, wind speed and/or cloud cover, could also be taken into account to improve the accuracy of the disaggregation, especially when considering the effects of the weather on HVAC systems and wind turbines.

According to step S3, at least one rated photovoltaic power is provided. These data refer to the installed capacity of photovoltaic systems and are beneficial for accurately estimating PV generation. This step could be extended to include rated power data for other types of DER, such as a capacity of battery storage systems and/or charging rates of EV charging stations. This additional information would further improve the accuracy of the disaggregation and provide a more comprehensive view of the available flexibility potential.

According to step S4, the grid meter data is disaggregated using machine learning algorithms to identify the distributed energy resources (DERs). This step involves analyzing the data provided in order to distinguish between different types of behind-the-meter assets. The machine learning algorithms could include a combination of supervised and unsupervised learning techniques, such as clustering algorithms to identify similar load patterns and classification algorithms to categorize different types of DER. Deep learning approaches, such as recurrent neural networks and/or transformer models, could be used to capture complex temporal dependencies in the data.

According to step S5, the flexibility potential for the identified behind-the-meter DERs is determined or ascertained. This step involves calculating the potential to adjust the electricity consumption and/or electricity generation based on the disaggregated data. For PV systems, this could include estimating the maximum possible curtailment during peak generation times. For battery storage systems, it could include calculating the available capacity for both charging and discharging. For EV charging, the flexibility potential could be determined based on historical charging patterns and the typical duration of charging procedures.

The flowchart illustrates a process in which each step builds on the data and analysis of the previous steps. However, feedback loops and iterative refinements could be used. For example, the disaggregation results in step S4 could be used to improve the accuracy of the rated PV power data in step S3 and/or to refine the interpretation of the weather data in step S2.

The method could also be extended to include additional steps for validation and uncertainty quantification. This could include comparing the disaggregated profiles with actual measurements of subordinate DERs, if available, and/or using statistical techniques to estimate the confidence intervals of the flexibility potential calculations.

The method illustrated in the figure provides a robust framework for extracting valuable information from aggregated net load profiles/grid power profiles and enables grid operators to make more informed decisions about grid management (control/regulation) and flexibility use. By using advanced data analysis techniques and including various data sources, this method addresses the growing need for improved visibility and control of behind-the-meter assets in modern electricity systems.

Although the teachings herein have been described and illustrated in more detail by way of exemplary embodiments, the teachings are not restricted by the disclosed examples, or other variations may be derived therefrom by a person skilled in the art without departing from the scope of protection of the disclosure.

1. A method for operating a power grid based on profiles for identifying a flexibility potential for behind-the-meter assets, the method comprising:
accessing time-dependent grid meter data;
accessing time-dependent weather data;
determining at least one rated photovoltaic power;
disaggregating the grid meter data using machine learning algorithms to identify distributed energy resources (DER);
determining a flexibility potential for the identified behind-the-meter DER; and
operating the power grid based on the flexibility potential.

2. The method as claimed in claim 1, wherein the DER include at least one of: PV systems, battery storage systems, or charging stations for electric vehicles.

3. The method as claimed in claim 1, wherein determination of the flexibility potential includes:
determining a maximum curtailment of PV production during a given period of time;
determining a maximum charging and/or discharging capacity of battery storage systems; and/or
determining a flexibility of the charging of electric vehicles based on historical charging statistics.

4. The method as claimed in claim 1, wherein disaggregation of the grid meter data includes identifying a share of a heating, ventilation, and/or air-conditioning system load.

5. The method as claimed in claim 4, wherein calculation of the flexibility potential includes calculating a lower limit for the flexibility of the heating based on the identified HVAC load share and a typical thermal inertia for a building at an outside temperature at its location.

6. The method as claimed in claim 1, wherein the method includes using transfer learning to estimate flexible assets and parameters of locations to be classified based on already classified behind-the-meter DER systems and their respective flexibility parameters.

7. The method as claimed in claim 1, wherein the machine learning algorithms include customizable rule-based algorithms and trainable machine learning algorithms.

8. A system for operating power grid based on disaggregated grid power profiles, the system comprising:
a module to access time-dependent grid meter data, time-dependent weather data, and rated photovoltaic power data from distributed energy resources (DER); and
a computing unit operable to:
disaggregate the grid meter data using machine learning algorithms to identify multiple DER;
determine the flexibility potential for the identified behind-the-meter DERs; and
operate the power grid based on the flexibility potential.

9. The system as claimed in claim 8, wherein the behind-the-meter DER include at least one: PV system, a battery storage system and/or a charging station for electric vehicles.

10. The system as claimed in claim 8, wherein the computing unit is operable to:
determine a maximum curtailment of PV production during a given period of time;
determine a maximum charging or discharging capacity of battery storage systems; and/or
determine a flexibility of the EV charging based on historical charging statistics.

11. The system as claimed in claim 8, wherein the computing unit is operable to identify a share of a heating, ventilation and/or air-conditioning system load during disaggregation of the grid meter data.

12. The system as claimed in claim 11, wherein the computing unit is operable to calculate a lower limit for the flexibility of the heating based on the identified air-conditioning system load share and a typical thermal inertia for a building at an external temperature at its location.

13. The system as claimed in claim 8, wherein the computing unit is operable to use transfer learning to estimate flexible assets and parameters of locations to be classified based on already classified behind-the-meter DER assets and their respective flexibility parameters.

14. The system as claimed in claim 8, wherein the machine learning algorithms include customizable rule-based algorithms and trainable machine learning algorithms.
